(19) United States
(12) Patent Application Publication
(10) Pub. No.: US 2009/0106257 A1
(43) Pub. Date: Apr. 23, 2009

(54) MULTIPLE-LINK SHORTCUTS BASED ON CONTEXTUAL ANALYSIS OF WEB PAGE OBJECTS

(75) Inventors: Alex Iskold, Livingston, NJ (US); Karen Teng, New York, NY (US); Andy Roth, Adamstown, MD (US); Rion Nakaya, Paris (FR)

Correspondence Address: DARBY & DARBY P.C., P.O. BOX 770, Church Street Station, New York, NY, 10008-0770, US

(73) Assignee: Adaptiveblue Inc.

(21) Appl. No.: 12/187,343

(22) Filed: Aug. 6, 2008

Related U.S. Application Data
(60) Provisional application No. 60/981,024, filed on Oct. 18, 2007.

(51) Int. Cl. G06F 17/30

(52) U.S. Cl. 707/10; 707/E17.032

(57) ABSTRACT

A multiple-link shortcut pane associated with an object on a web page provides multiple Internet links dynamically selected based in part on an object type of the object. The shortcut pane is invoked by launching a shortcut launcher icon on the web page, which causes an object key to be transmitted to a shortcut server. The shortcut server retrieves identifying information for the object from a database based on the object key, and an object type-specific template based on the object type. The object type is determined from the identifying information. The shortcut server then prepares and transfers information for building the multiple-link shortcut pane to the browser application that displays the web page. The shortcut pane may be further configured to capture and provide additional information about viewers who have accessed the pane, and actions they have taken.

### CROSS-REFERENCE TO RELATED APPLICATION

The present application claims priority under 35 U.S.C. §119(e) to U.S. Provisional Patent Application No. 60/981,024, which was filed on Oct. 18, 2007 and is hereby incorporated by reference herein in its entirety.

### FIELD OF THE INVENTION

The present invention relates to a multiple-link shortcut pane associated with an object presented on a web page or blog, and more particularly, to a multiple-link shortcut pane in which the pane is dynamically constructed to include links and other types of information which are included based on an identified object type of the object.

### BACKGROUND OF THE INVENTION

In web-based computer applications, shortcuts are well known devices that, for example, enable easy access from one web page to another web page bearing some relation to the first web page. The shortcuts are often provided in reference to a particular element or object on the web page. For example, AMAZON.COM may present a web page associated with a particular book (e.g., “Harry Potter and the Deathly Hallows”) which presents a shortcut link associated with the book's author (“J. K. Rowling”). When the author shortcut link is activated, the viewer is taken to another web page which provides information about other books and products at the AMAZON.COM site that are associated with J. K. Rowling.

While such shortcut links may be somewhat useful in assisting a viewer of the book page to view a few web pages having related content, they do not typically reach the full variety of related web pages that viewers may be interested in reaching when viewing a web page that is associated with a book. For example, it is unlikely that the AMAZON.COM web page will provide a link by which the viewer may comparatively price the book with other vendors (e.g., BARNES&NOBLE.COM), share information about the book on a personal web page (e.g., FACEBOOK), and the like. Therefore, it would be of benefit to provide a means by which multiple shortcut links which may be of interest to a viewer who is viewing an object of a given type on a web page are automatically made available to that viewer based on the type of object being viewed.

### SUMMARY OF THE INVENTION

The present invention is directed to a novel multiple-link shortcut pane created for an object presented on a web page, and to methods for creating, publishing and using such shortcut panes.

The multiple-link shortcut pane associated with an object on a web page provides multiple Internet links dynamically selected based in part on an object type of the object. The shortcut pane is invoked by launching a shortcut launcher icon on the web page, which causes an object key to be transmitted to a shortcut server. The shortcut server retrieves identifying information for the object from an object database based on the object key, and an object type-specific template based on the object type. The object type is determined from the identifying information. The shortcut server then prepares and transfers information for building the multiple-link shortcut pane to the browser application that displays the web page. The shortcut pane may be further configured to capture and provide additional information about viewers who have accessed the pane, and actions they have taken.

For purposes of brevity, the inventive multiple-link shortcut pane is hereafter referred to as a “SMARTLINKS pane,” and individual ones of the multiple-link shortcuts are referred to as “SMARTLINKS.”

Unlike conventional links that simply point to web pages, SMARTLINKS point to objects (e.g., things like books, movies, music albums, restaurants, wine, blogs, travel destinations, MP3 players and the like).

Each SMARTLINK is based on an underlying object, which is preferably associated with an entry in an object database. The object database includes a predetermined set of metadata that describe each object. For example, for a book, the database entry may include a title, author(s) and a publication date. For a movie, the database entry may include a title, director, stars, release year, and so on.

Each SMARTLINK has associated with it a set of contextual shortcut links, which vary depending on the underlying object type. Shortcut links for different object types (e.g., books, music and movies) are therefore different. A SMARTLINK can be effectively considered to be a multilink to various sources of information related to the underlying object.

SMARTLINKS are preferably formed to support actions typically taken by a viewer with respect to an object. For a book, for example, the viewer may read the book, borrow the book, or may give it a rating. For a movie, the viewer may rent the movie from BLOCKBUSTER, or attend a premier viewing at a theater. Thus, for each type of object, there is an associated set of actions identified as actions typically taken by a viewer. A SMARTLINKS object type template is used to identify the types of actions for which links are to be created on the SMARTLINKS pane.

### BRIEF DESCRIPTION OF THE DRAWINGS

The invention will become more readily apparent from the Detailed Description of the Invention, which proceeds with reference to the drawings, in which:

FIG. 1 illustrates the presentation of SMARTLINKS launcher icons on a web page;

FIG. 2 illustrates a SMARTLINKS launcher for invoking a SMARTLINKS launcher icon;

FIG. 3 presents a schematic diagram of a system for presenting a SMARTLINKS pane in response to user selection of a SMARTLINKS launcher icon;

FIG. 4 presents a schematic diagram illustrating elements of a general-purpose server used in the system of FIG. 3;

FIG. 5 illustrates an exemplary SMARTLINKS pane;

FIG. 6 illustrates the SMARTLINKS pane of FIG. 5, further including icons identifying recent visitors to the SMARTLINKS pane;

FIG. 7 illustrates the SMARTLINKS pane of FIG. 6, further including a secondary window presenting information associated with a recent visitors icon;

FIG. 8 illustrates the SMARTLINKS pane of FIG. 5, further including a recent activity timeline;

FIG. 9 illustrates the SMARTLINKS pane of FIG. 8, further including a secondary window presenting information associated with an entry in the recent activity timeline; and

FIG. 10 illustrates an alternate SMARTLINKS launcher icon pane for promoting social networking by associating people with objects.

### DETAILED DESCRIPTION OF THE INVENTION

The following description presents principles of the present invention in greater detail, including descriptions of how SMARTLINKS launcher icons may be presented on a web page, how SMARTLINKS panes are invoked by the launcher icons, and how content is selected for and presented in the SMARTLINKS panes.

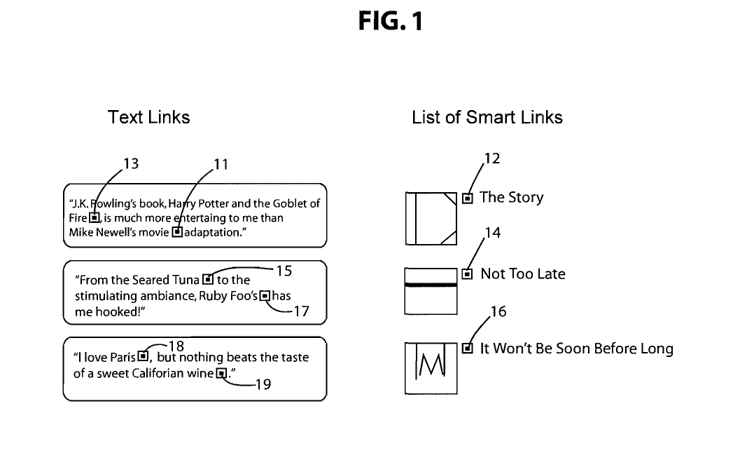

FIG. 1 illustrates how SMARTLINKS may be represented on a web page by an icon (“the SMARTLINKS launcher”). For example, as shown in FIG. 1, SMARTLINKS launcher icons 11, 13, 15, 17, 18 and 19 may be embedded in paragraphs adjacent to text links for associated objects of interest. For example, SMARTLINKS launcher icon 13 is positioned adjacent to a text link to as AMAZON.COM page for the book “Harry Potter and the Goblet of Fire.” Alternatively, SMARTLINKS launchers 12, 14 and 16 may embedded along side icon-based links (for example, pictorial thumbnails) that may be arranged, for example, in a list or grid format on the web page.

In a preferred embodiment of the present invention, SMARTLINKS launchers are embedded on a web page by creating html code to be added to the html code that implements the web page. A JavaScript script is then invoked from the html code that creates the SMARTLINKS launcher icon at the time that html code is invoked to display the web page.

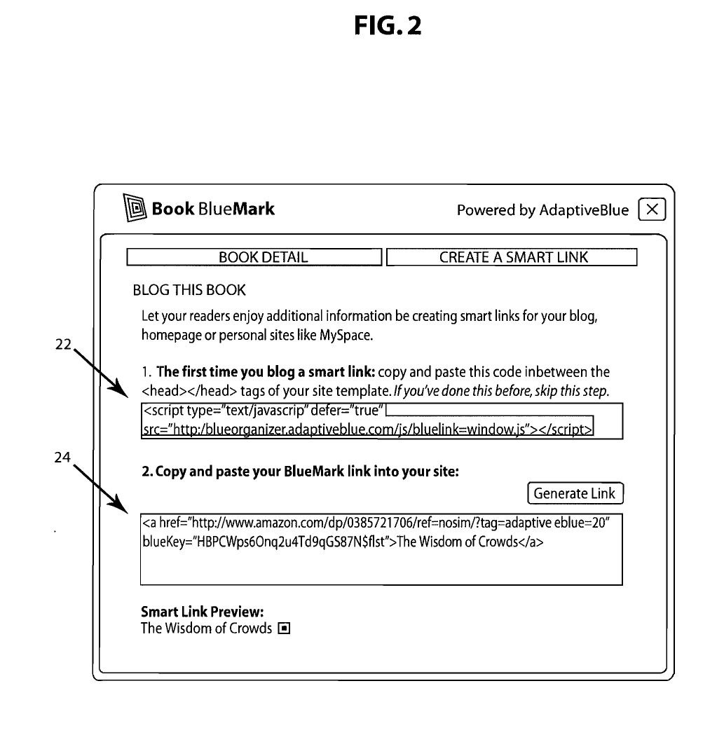

FIG. 2 illustrates an exemplary window providing a user with the html code for embedding SMARTLINKS launchers. A JavaScript script 22 is added to the head of the html document for the web page. The script 22 indicates that the necessary SMARTLINKS code may be retrieved from a web-accessible server (referred to hereafter as “the ADAPTIVEBLUE server”), accessible at the URL provided in the following “src” command:

<script type=“text/javascript” defer=“true”
src=“http://blueorganizer.adaptiveblue.com/js/bluelink-window.js”>
</script>

Each SMARTLINK launcher to be provided on the web page is then designated by a marker. A marker can be explicit or implicit. An explicit marker, for example, is illustrated in FIG. 2 as HTML element 24 as shown below, which includes an attribute called “blueKey” as highlighted below:

<a href=“http://www.amazon.com/dp/0385721706/ref=nosim/?tag=
adaptiveblue-20”
blueKey=“HBPCWps6ONQ2u4Td9qGS87N4fIst”>The
Wisdom of Crowds</a>

The blueKey is prepared by another JavaScript script that intelligently analyzes information on the web page of an associated link in order to uniquely identify the object that is associated with the link(in this case, a book). The blueKey may then be stored, for example, in a database where the SMARTLINKS code is kept.

Alternatively, an implicit SMARTLINK can be identified based on characteristics of a particular web site's uniform resource locator (URL). For example, the JavaScript script can be configured to transform all present URL links on the web page that can be identified as pointing to AMAZON.COM web pages for books into SMARTLINKS for books.

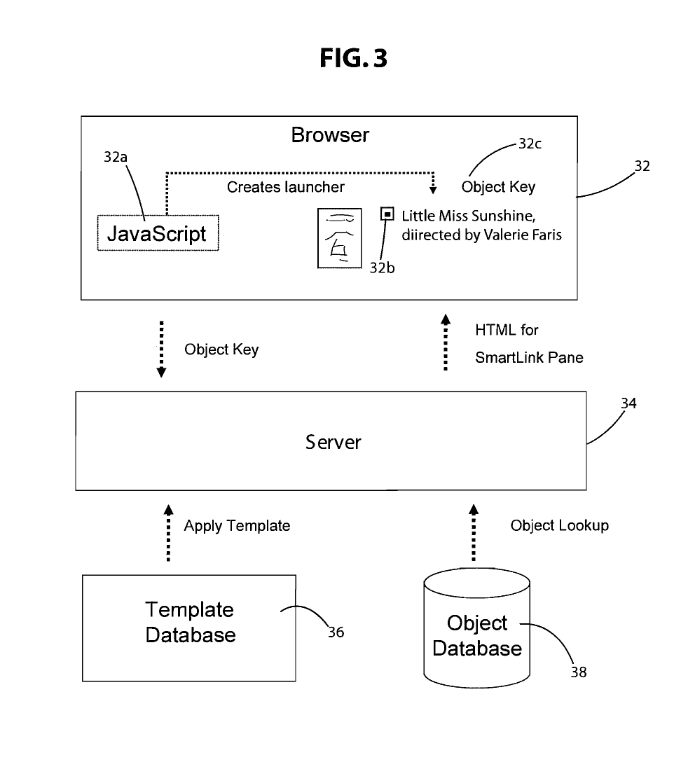

FIG. 3 presents an exemplary system for presenting a SMARTLINKS pane to a user in response to the user's selection of a SMARTLINKS launcher icon on a web page viewed via the user's browser. As shown in FIG. 3, by clicking on the SMARTLINKS launcher 32b, a JavaScript script 32a is invoked by the user's browser 32, The invoked script 32a operates to pass an object key (“blueKey”) 32c for the associated object to the ADAPTIVEBLUE server 34, which executes a server script that retrieves an object type-specific template from a template database 36 based on the object key 32c, and object data from an object database 38 based on the object key 32c.

The ADAPTIVEBLUE server 34 transfers this data to the user's browser 32, where the SMARTLINKS pane (“SMARTPANE”) may be rendered for the user by an associated JavaScript script. Communications between the browser 32 and the ADAPTIVEBLUE server 34 may be carried out, for example, based on Asynchronous JavaScript with XML (Ajax).

The object type-specific template defines the elements and organization of the SMARTLINKS pane, and preferably includes search-oriented links which can be populated with portions of the object data which function as search terms. For example, the book object-type template may include AMAZON.COM and BARNES AND NOBLE search URLs which can be populated with object data for the author in order to create the “Books: Amazon, Barnes and Noble” link 56 of FIG. 3. Because these search-oriented links are invoked each time a viewer selects an associated link on the SMARTLINKS pane, the information associated with the search is freshly retrieved and current.

The ADAPTIVEBLUE server 34 may preferably include one or more conventional server-type computers, capable of supporting a large number of user requests simultaneously. These conventional server-type computers are capable of sending and receiving information over the Internet, storing, retrieving, and maintaining files, and running various applications, as is well known by those skilled in the art.

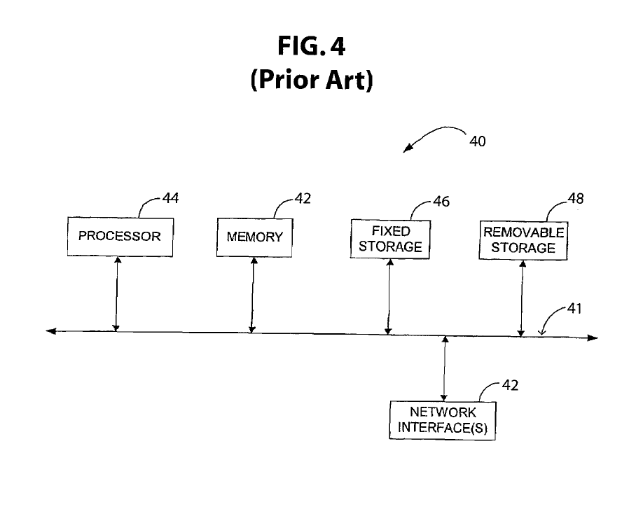

For example, the ADAPTIVEBLUE server 34 may preferably comprise a conventional, LINUX-based web server as is well-known in the art. FIG. 4 presents a schematic diagram a general-purpose server 40 as would be suitable for such use. The computer system 40 preferably includes a memory 42 (for example, a RAM/ROM memory), a central processor 44, fixed storage 46 (for example, a hard drive), removable storage 48 (for example, a CD-ROM drive), and one or more network interfaces 70 (for example, a NIC card for interconnection to the Internet), which communicate with each other over a system bus 41.

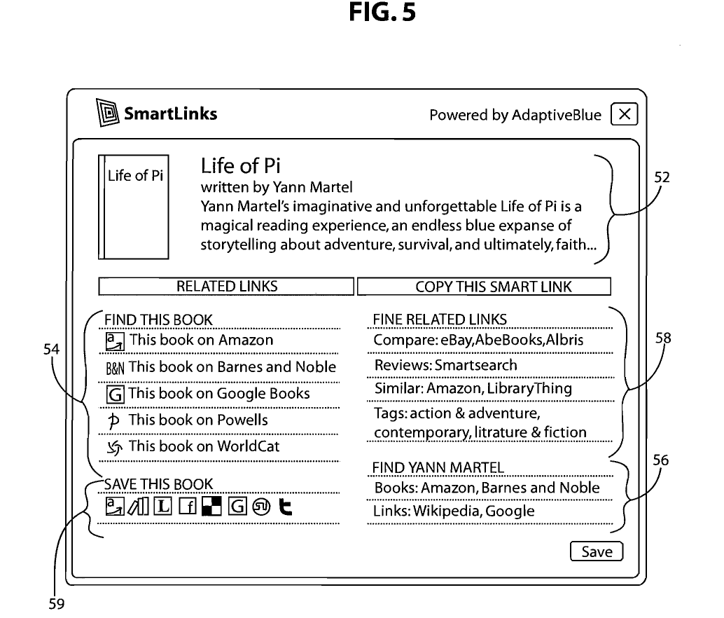

FIG. 5 illustrates a SMARTLINKS pane 50 that is produced by the system of FIG. 3 for display by the user's browser 32. For purposes of illustration, the pane 50 presents information about “Life of Pi,” which is an object having an object-type of “book.” The SMARTLINKS pane 50 for “Life of Pi” contains, for example, identifying information 52 for the book (e.g., a text summary and thumbnail of the front cover) and one or more groupings of selectable links prepared based on the associated object type “book”. Object type book in this case includes a grouping of links 54 for finding the book at various booksellers and a grouping of links 56 associated with the author of the book (Yann Martel). The grouping 56 may for example include links to find other books by the author, and links to biographical information about the author. Object type book also includes a grouping of other related links 58 (for example, links to book reviews for “Life of Pi” and lists of related/similar books) and a grouping of action links 59 (for example, for adding “Life of Pi” to an AMAZON.COM wish list or for saving information about the book to a personal web page on FACEBOOK as a “favorite”).

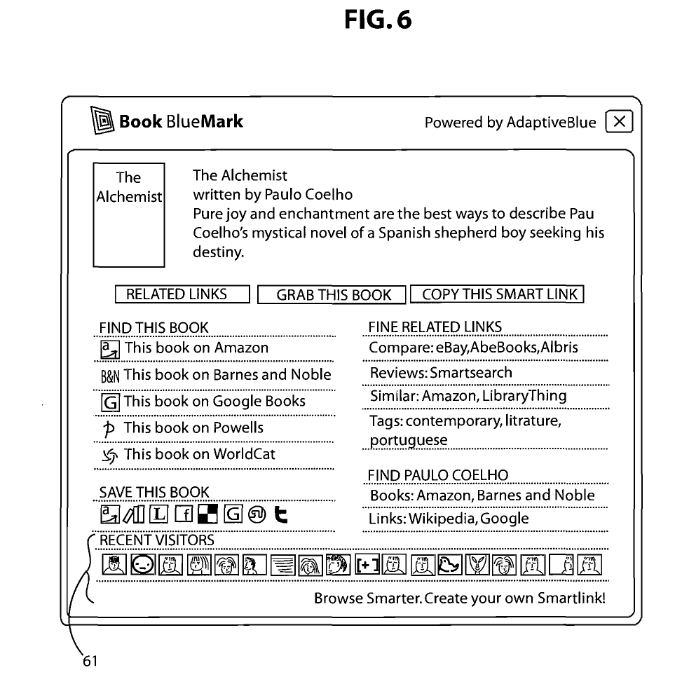

As illustrated in FIG. 6, the SMARTLINKS pane may in addition include a “recent visitors” grouping of icons 61 for accessing information about actions taken by members of the population of users who have accessed the SMARTLINKS pane from the web page in which the SMARTLINKS launcher or icon has been embedded.

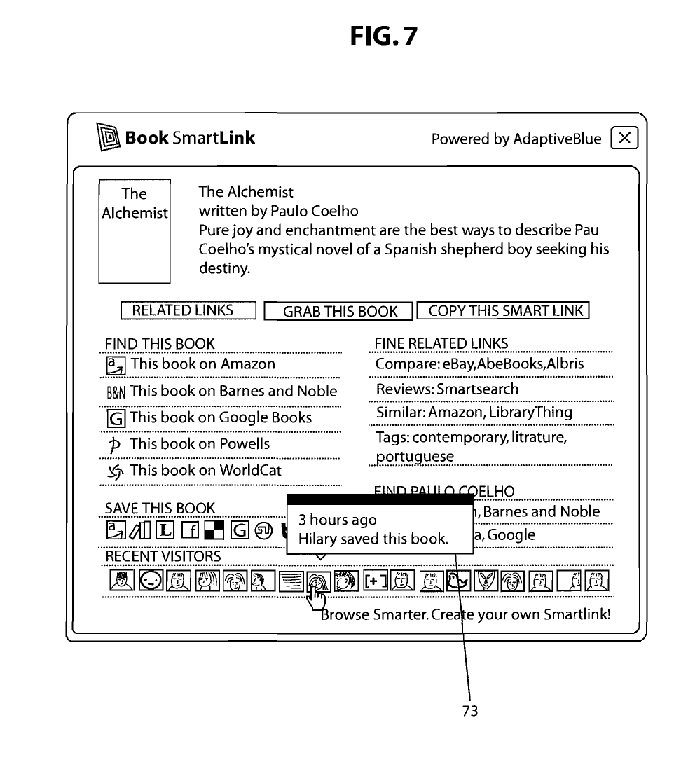

The icons 61 may preferably identify recent visitors to the web page who have accessed the SMARTLINKS pane, for example in an order that is representative of the time of their most recent visits. This effectively provides a “people timeline”. The icons can be pointed to by a viewer's mouse (i.e. by performing a “mouseover”) or otherwise activated (for example, by clicking a left or right mouse button upon performing the mouseover) to provide additional information about the visits (for example, time of access and action taken by the visitor). For the object type “book,” actions reported may include one or more of looking at the book, saving the book, reviewing the book and rating the book. FIG. 7 illustrates a pop-up window 73 that is generated in response to a user selection of one of the “recent visitors” icons, indicating that “Hilary saved this book” at a time that was “3 hours ago.”

Alternatively, the SMARTLINKS pane can be configured to present icons that indicate the objects that visitors interact with, preferably in an order that is representative of the time of the most recent interaction (in effect, providing an “object timeline”). The object icons may be pointed to for obtaining additional information about the most recent interaction (for example, the identity of the most recent visitor and/or identities of other visitors that recently interacted with the object).

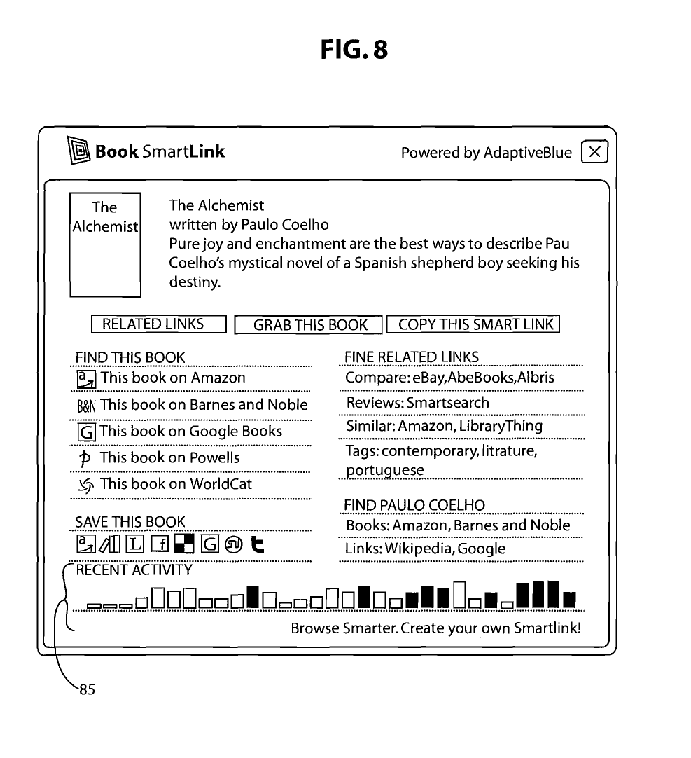

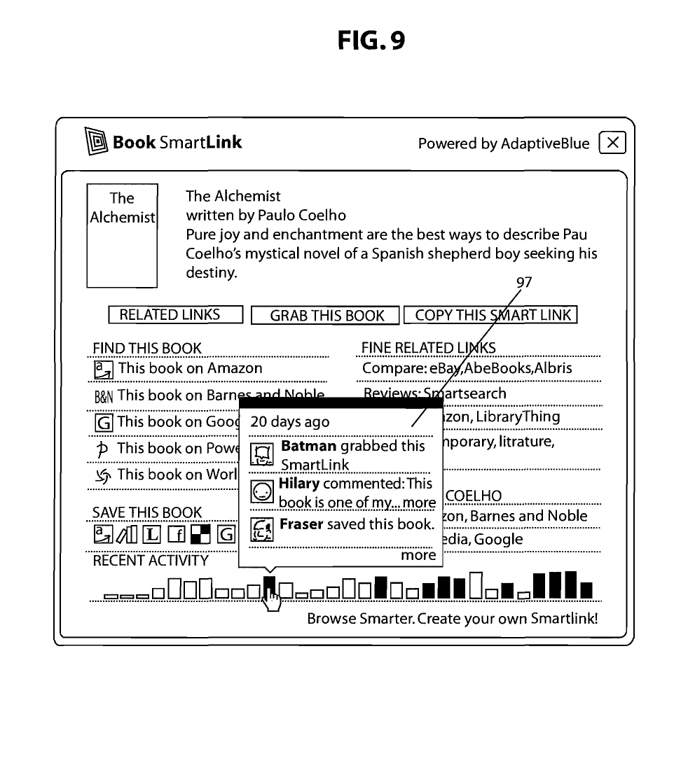

As shown in FIG. 8 as another alternative, a “recent activity” timeline 85 may be presented as a histogram (or other suitable graphical representations) to show a level of visit activity time (effectively presenting a “popularity timeline”). As shown in FIG. 9, one of the histogram “stacks” may be pointed to in order to obtain a pop-up 97 that provides additional information about accesses made to the SMARTLINK for “The Alchemist” over a representative period of time (for example, accesses within the last 28 days).

Information needed for providing the “recent visitor” features as described above can be readily captured with the operation of the SMARTLINKS panes. Each SMARTLINKS pane for example can be configured to include a JavaScript script that gets triggered when the pane is opened. The JavaScript script operates to record information about each visitor and visit in an interaction record via a conventional cookie mechanism, and then post the interaction record to a database (for example, a database created using AMAZON.COM's SimpleDB database and web service). Each interaction record may, for example, include an object identifier for the object associated with the SMARTLINKS pane, information about the visitor and visit location (i.e., visited web site), and information about the visitor's interactions (i.e., SMARTLINKS links invoked by the visitor). When another visitor clicks on an object icon to fetch the SMARTLINKS pane, an object identifier is forwarded to the SimpleDB web service, and information about previous interactions with the object is returned by the web service for display in the SMARTLINKS pane or an associated adjunct pane. For example, upon receiving the object identifier, the SimpleDB web service may reply by providing a list of recent visitors, encoded as HTML for display in an adjunct pane.

As is evident from the preceding description, a SMARTLINK pane may be configured to enable web page visitors to easily take a variety of actions relating to the object associated with the SMARTLINK pane and its object type. The following are examples of typical actions that could be taken by visitors to a SMARTLINK pane:
Kate looked at a SMARTLINK to a book on Mary's blog, and learned that John had viewed details about the same book at AMAZON.COM.
Peter looked at a MICROSOFT SMARTLINK at YAHOO!FINANCE to learn that Jane had given MICROSOFT stock (ticker symbol MSFT) a rating of five stars. Peter contacted Jane to further explore their mutual interest in stocks.
Helen reviewed a recipe SMARTLINK for pasta at 101COOKBOOKS.COM, rated the recipe and added the recipe to a personal collection.
Josh looked at a music album SMARTLINK on Allen's blog to view Allen's music collection and discover a great new artist he had not been aware of.
Dan looked at a SMARTLINK to a book that he had blogged to discover that more visitors viewed his book collection than his music collection.

Accordingly, by incorporating information about visitors (as described above, for example, with reference to FIGS. 6-9), SMARTLINKS provide a mechanism for connecting people (visitors) around things (objects).

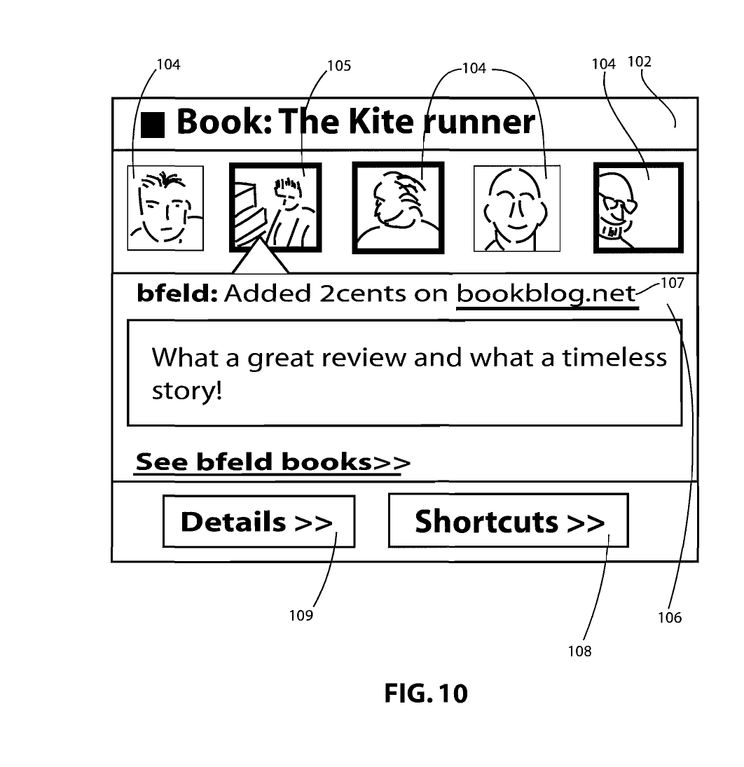

FIG. 10 illustrates an alternate SMARTLINKS launcher icon pane further promote social networking among people who have visited a SMARTLINK for a particular object. In FIG. 10, a SMARTLINKS launcher icon pane 100 identified an object of type “book” (“The Kite Runner”) in a header 102, and provides icons 104, 105 identifying people who have recently visited the pane or are otherwise associated with the book “The Kite Runner.” By pointing to one of the icons 104, a pop-up 106 is invoked which provides a summary of review information prepared by the subject of the icon 105 (“bfeld”), a link 107 to a webpage 107 at which the full review cant be obtained, and additional buttons 108, 109 for accessing SMARTLINKS and other details provided in the associated SMARTLINKS pane.

As illustrated by the examples of FIGS. 5-10, SMARTLINKS can effectively be used to create a personal station or portal for viewers that links a variety of relevant information to a particular viewer context. SMARTLINKS become not just starting points for relevant searching about objects, but become viewing destinations as well. Benefits of SMARTLINKS include, for example, the following:
Viewers may be easily connected to a great variety of common interest groups.
SMARTLINKS increase the rate at which visitors discover new objects of interest (for example, books, music, movies, stocks and the like)
VIEWERS are able to quickly discover and save particularly relevant information at their own personal web pages.

Those skilled in the art will readily recognize numerous adaptations and modifications which can be made to the present invention which fall within the spirit and scope of the present invention as defined in the claims. Moreover, it is intended that the scope of the present invention include all foreseeable equivalents to the elements and structures as described with reference to FIGS. 1-10. Accordingly, the invention is to be limited only by the scope of the claims and their equivalents.

1. A method for creating a multiple-link shortcut pane providing access to information that is associated with an object that is described or displayed on a web page, the web page being rendered on the viewing screen of a computer, the method comprising the steps of:
determining an object type of the associated object;
determining identifying information for the object, wherein the identifying information is determined according to the object type;
storing the identifying information in a database;
preparing a key for retrieving the identifying information from the database;
writing database location information to the web page for accessing the database; and
writing marker information to the web page, wherein the marker information specifies the key for retrieving the identifying information from the database;
wherein the identifying information further identifies the object type for retrieving an object type-specific template that is applied to the identifying information for preparing the multiple-link shortcut pane.

2. The method according to claim 1, further comprising the step of:
scanning the web page to identify a link that is associated with the object,
determining the object type and the identifying information by extracting information from a web page of the link.

3. The method according to claim 1, further comprising the step of:
inserting a semantic marker in the web page for accessing the multiple-link shortcut pane.

4. The method according to claim 1, wherein the step of preparing the key further comprises the steps of:
binding the identifying information stored in the database to the object type-specific template, the object type-specific template being stored in a template database.

5. A method for invoking a multiple-link shortcut pane providing access to information that is associated with an object that is described or displayed on a web page, the web page being rendered on the viewing screen of a computer by a browser application, the method comprising the steps of:
receiving an object key of the object from the browser application at a shortcut server;
retrieving identifying information of the object from a database based on the object key;
determining an object type based on the object key;
retrieving an object type-specific template based on the object key;
creating information for building the multiple-link shortcut pane based on the object type-specific template and the identifying information;
transferring the information for building the multiple-link shortcut pane by the shortcut server to the browser application for rendering the multiple-link shortcut pane on the viewing screen of the computer.

6. A multiple-link shortcut pane providing access to information that is associated with an object that is described or displayed on a web page rendered on the viewing screen of a computer by a browser application, the multiple-link shortcut pane being rendered on the viewing screen of the computer by the browser application and comprising:
one or more links to web pages providing access to the object; and
one or more links to web pages providing information about a predetermined attribute of the object;
wherein the predetermined attribute is selected according to an object type of the object.

7. The multiple-link shortcut pane according to claim 6, wherein the one or more links to web pages providing access to the object include at least one link to a provider of the object.

8. The multiple-link shortcut pane according to claim 7, wherein the provider is an on-line provider associated with one of the web pages providing access to the object.

9. The multiple-link shortcut pane according to claim 6, wherein the one or more links to web pages providing information about a predetermined attribute of the object provide at least one link to a web page providing information about another object that shares the predetermined attribute.

10. The multiple-link shortcut pane according to claim 6, wherein the multiple-link shortcut pane further comprises:
one or more links to web pages capable of storing information about the object in association with information about the viewer.

11. The multiple-link shortcut pane according to claim 6, wherein the multiple-link shortcut pane and web page are capable of being rendered on the viewing screens of a plurality of computers for viewing by a plurality of viewers, the shortcut pane further comprising:
information about accesses made to the shortcut pane by the plurality of viewers.

12. The multiple-link shortcut pane according to claim 11, wherein
information about accesses further includes information about actions taken by the plurality of viewers.

13. The multiple-link shortcut pane according to claim 11, wherein
information about accesses further includes information about the plurality of viewers.

14. The multiple-link shortcut pane according to claim 6, wherein the multiple-link shortcut pane further comprises:
a description of the object.

15. The multiple-link shortcut pane according to claim 14, wherein elements of the description of the object are determined according to the object type.

16. The multiple-link shortcut pane according to claim 14, wherein the description of the object includes a thumbnail illustration of the object.

17. The multiple-link shortcut pane according to claim 6, wherein
the object type is selected from the group consisting of books, movies, music, stocks, restaurants, wines, images, video, and recipes.

18. A multiple-link shortcut pane providing access to information that is associated with an object that is described or displayed on a web page rendered on the viewing screen of a computer by a browser application, the multiple-link shortcut pane being rendered on the viewing screen of the computer by the browser application and comprising:
one or more links to web pages organized to provide information about the object; and
at least one link to a web page organized to provide information about a predetermined attribute of the object, wherein the predetermined attribute is selected according to an object type of the object and the web page associated with the at least one link provides information about at least another object that shares the predetermined attribute of the object.
